(19) United States
(12) Patent Application Publication
(10) Pub. No.: US 2009/0238986 A1
(43) Pub. Date: Sep. 24, 2009

(54) Alkali-Resistant Sol-Gel Coating

(76) Inventors: Frank Gross, Saarlouis (DE); Gerd Schlick, Freyming-Merlebach (FR); Stefan Sepeur, Wadgassen (DE)

Correspondence Address: COLLARD & ROE, P.C., 1077 NORTHERN BOULEVARD, ROSLYN, NY, 11576, US

(21) Appl. No.: 11/922,297

(22) PCT Filed: Jun. 12, 2006
(86) PCT No.: PCT/DE2006/001002

§ 371 Date: Dec. 31, 2007

(30) Foreign Application Priority Data
Jun. 15, 2005 (DE) 10 2005 027 789.6

(51) Int. Cl. B05D 1/04; C08G 77/14; C09D 183/06; B05D 1/28; B05D 1/02; B05D 1/18; B05D 3/12; B05D 3/02

(52) U.S. Cl. 427/458; 528/39; 524/588; 427/428.01; 427/427.4; 427/430.1; 427/240; 427/387

(57) ABSTRACT

The invention relates to alkali-resistant sol-gel coatings, a process for producing alkali-resistant sol-gel coatings and use thereof.

To provide alkali-resistant sol-gel coatings, a coating is proposed within the scope of the invention that consists of
a hydrolysable silane of the compounds TEOS, MTEOS or higher-chain alkyl silanes (di- tri- and tetrafunctional silanes), but preferably TEOS, MTEOS or mixtures thereof
and a condensation catalyst based on
   a) secondary or tertiary bases (e.g. amino, mercaptosilanes)
and/or
   b) Lewis acids as metal alkoxides, such as aluminium alkoxides, zirconium alkoxides and titanium alkoxides
where the ratio (in wt. %) of hydroysable silane to condensation catalyst is between 99:1 and 70:30.

The invention relates to an alkali-resistant sol-gel coating, a process for producing an alkali-resistant sol-gel coating and use thereof.

High resistance to alkalis is desired particularly for sanitary and kitchen applications. The service life of coatings is usually tested in dishwashers with addition of alkaline cleaning agents. Broadly speaking, systems are known which, on account of their silicate structure, are highly resistant to acids. When tested for their alkali resistance, commercial sol-gel systems have been shown to fail after a maximum of 20-30 cycles.

The DD 280 956 A1 describes a method of producing coatings based on an organic polyester, which protect glass surfaces from alkaline corrosion.

The DE 40 25 215 C2 describes the production of alkali-resistant, abrasion-proof coatings. It describes the production of coating materials by reacting silanes containing non-hydroysable primary, secondary and/or tertiary amino groups with organic epoxides. For this reaction, the coating solutions must have at least one component with amino groups on the non-hydrolysable moiety and one component with at least two epoxy groups. In a dishwasher test for alkali resistance (immersed for 2 h in 3% Somat solution), no changes were observed in the coating layer.

Coatings based on hydrolysates and condensates of pure organosilanes are not characterised by excessively good alkali resistance, since, on account of their chemical nature, the siloxane bond (≡Si—O—Si≡) can be attacked relatively easily by hydroxide ions according to the following reaction:

≡Si—O—Si≡+⁻OH/H₂O→[≡Si—OH+⁻O—Si≡+H₂O]→≡Si—OH+HO—Si≡+^{—}OH

siloxane cation/H₂O intermediate silanol cation

In an alkaline medium, the siloxane bond hydrolyses under the catalytic influence of hydroxide ions to form silanols. As a result, the inorganic polymer network, and hence also the coating, is destroyed.

The object of the invention is accordingly to provide an alkali-resistant sol-gel coating.

This object is established according to the invention by an alkali-resistant coating consisting of
a hydrolysable silane of the compounds TEOS, MTEOS or higher-chain alkyl silanes (di- tri- and tetrafunctional silanes), but preferably TEOS, MTEOS or mixtures thereof
and a condensation catalyst based on
   a.) secondary or tertiary bases (e.g. amino, mercaptosilanes) and/or
   b.) Lewis acids as metal alkoxides, such as aluminium alkoxides, zirconium alkoxides and titanium alkoxides
      where the ratio (in wt. %) of hydroysable silane to condensation catalyst is between 99:1 and 70:30.

Surprisingly, it was found that the alkali resistance of sol-gel systems based on silanes without organically functional side chains (MTEOS and higher-chain alkyl silanes up to C30, TEOS) is significantly improved—that is, these systems do not fail even after 200 to 300 dishwasher cycles—by condensation catalysts based on

1. secondary or tertiary bases (e.g. amino, mercaptosilanes) and/or

2. Lewis acids such as aluminium alkoxides, zirconium alkoxides and titanium alkoxides.

Use of the above-listed Lewis acids or secondary or tertiary amino compounds (e.g. N-butylaminopropyltrimethoxysilane or N-methylaminopropyltrimethoxysilane)—referred to in the following as “curing catalysts”—permits a significant reduction in the drying temperature required for the coatings. For example, with drying temperatures between 60 and 80° C., transparent coatings may be produced which already show good-to-very-good adhesion and abrasion resistance on PVC, polycarbonate or other commonly used plastics. The thickness of the coating layers applied varies between 0.01 μm and 20 μm, depending on the application in question. The curing catalysts may be added either directly at the start of the sol-gel synthesis or they may be added later to the finished coating solution.

This means it is also possible to formulate multi-component surface coatings that have a stable pot life (e.g. two-part systems comprising a binder and a catalyst).

Pigments or fillers may also be dispersed ad libitum in the described coating systems. Additionally, additives employed routinely in the surface coatings industry (e.g. Byk additives for improving flow/leveling properties, substrate wetting or pigment wetting) may be used as required.

A development of the invention consists in that the coating is diluted with a solvent, especially water, to a solids content of more than 0.05 wt. % and less than 20 wt. %.

It is also expedient that for purposes of surface functionalization, a portion of the alkoxysilanes is fluorinated or contains a hydrophilic side chain, especially polyether.

According to the invention, the metal alkoxides are preferably aluminium alkoxides and zirconium alkoxides.

Likewise according to the invention, the bases are silanes with a secondary amino group.

It is also to good effect that the coating contains nanoparticles, in particular SiO₂ nanoparticles.

The scope of the invention includes a process for producing a coating according to the invention, in which process acid is added to hydrolyse the silane and the catalyst is added immediately after hydrolysis or up to 1 h after hydrolysis.

It is intended that the coating be applied by way of roll coating, flooding, spray painting, electrostatic spraying, centrifugal coating, dip coating or wipe coating.

A development of the invention consists in that curing of the coating is effected at room temperature (RT) up to 1,200° C.

It is also expedient that the coating is applied as a primer or a thin layer of up to 3 μm coating thickness to the object to be coated.

The scope of the invention furthermore includes use of the coating of the invention on metals, especially steel and chromium, metallized plastics, polymers, especially PVC and polyester, glass, ceramics, glass ceramics, natural materials, especially leather, rubber, jute, and cotton, and mineral substrates, especially stone and concrete.

Likewise within the scope of the invention is the use of the coating of the invention as a primer for hydrophobic coatings or photocatalytically active particles and for non-scaling coatings on chromium surfaces, stainless steel surfaces, PVC or polyester.

The invention also provides for use of the coating of the invention as a base system for anti-fingerprint, photocatalytic and non-scaling coatings, matting agents, paint pigments and flow improvers, for impregnating textiles, leather and paper or as a binder or additive for surface coating systems or polymers.

The invention provides ultimately for use of the coating of the invention on household crockery, household appliances, textiles and kitchen and sanitary equipment, in particular on pots, pans, housings of all kinds, fittings, covers, trim, hand-towel holders, paper dispensers, hand dryers, soap dispensers, shower heads, mirror frames, bath-tub and wash-basin closures, shower rails, shower panels, bathroom furniture, lamellae and PVC profiles (window frames, doors, conservatories), facade elements, roller-shutter boxes, sunblinds, textiles, especially industrial fabrics such as awnings, tent roofs and tarpaulins, or (clothing) materials.

The invention is explained below by means of examples:

### EXAMPLE 1

Primer: 20.8 g TEOS are stirred for 1.5 h with 14.4 g 0.1% H₂SO₄ (monophase). The solids content is reduced to 1% by dilution with butyl glycol and then 1.2 g N-methylaminopropyltrimethoxysilane are added.

Functional layer: 5 g dodecyltrimethoxysilane are mixed with 100 g isopropanol and 25 g 1% HCl, and stirred for 1 h at room temperature. The clear solution is then diluted with 900 g isopropanol.

To start with, the primer is sprayed onto the cleaned chromium surface. After 5 minutes (flash-off), the functional layer is sprayed on. Curing is effected at 80° C. for 20 minutes.

Results: The coating layer shows pronounced water repellency and a contact angle for water of 110°. The coating significantly facilitates the removal of scale. Even after two hours' immersion in boiling dishwasher solution (10% Alio solution, pH 11.5), the coating still has a contact angle greater than 100° and scale adhesion is poor.

### EXAMPLE 2

Primer: 20.8 g TEOS are stirred for 1 h with 7.2 g 1% H₂SO₄. The solids content is reduced to 1% by dilution with demineralized water and then 1.4 g 3-aminopropyltrimethoxysilane are added.

Functional layer: 5 g dodecyltrimethoxysilane are dissolved in 1000 g 1-butanol and mixed with 20 g 1% H₂SO₄.

To start with, the primer is sprayed onto the cleaned chromium surface. After 5 minutes (flash-off), the functional layer is sprayed on. Curing is effected at RT for 180 minutes.

Results: The coating shows pronounced water repellency and a contact angle for water of 105°. The coating significantly facilitates the removal of scale. Even after one hour's immersion in boiling dishwasher solution (10% Alio solution, pH 11.5), the coating still has a contact angle greater than 100° and scale adhesion is poor.

### EXAMPLE 3

20.0 g MTEOS, 5.8 g TEOS and 6.8 g 5% acetic acid are stirred for 24 hours. The solids content is reduced to 10% by dilution with 42.9 g butyl glycol.

1.3 g zirconium butylate (80% in n-butanol) are dissolved in 1.8 g n-butanol and mixed with 0.2 g acetylacetone by stirring. The solution turns yellow and slightly warm. Stirring is continued for one hour. The zirconium complex is then stirred into the above-described MTEOS-TEOS hydrolysate solution.

Cleaned stainless steel sheets are spray-coated with the solution from Example 3 and dried for 1 h at 220° C.

Results: The coated stainless steel specimens show pronounced water repellency and a contact angle for water of more than 90°. The coated specimens show anti-fingerprint properties, i.e. fingerprints left on the surface do not leave any traces of blue tarnish, even after several hours, and are therefore hardly perceptible on the surface. The fingerprints may be removed easily with a dry paper or cotton cloth. No changes in the coating layer (opacity, detachment . . . ) are evident after 8 hours' boiling in tap water. Scale residues deposited on the surface by boiling may be removed easily with an acidic surfactant cleaning agent. In an additional, accelerated exposure test, the specimens were boiled for 8 h in dishwasher solution (10% Alio solution, pH 11.5). The coated specimens were also cleaned under standard conditions in a household dishwasher for a period of 300 program cycles. No detachment or coating damage was observed after either of the two test methods. The above-mentioned anti-fingerprint effect was likewise maintained.

### EXAMPLE 4

5.0 g Levasil 200S silica sol (Bayer) are mixed with 5.0 g acetic acid and 6 g N-butylaminopropyltrimethoxysilane and stirred for 2 h at RT. The solution is then diluted with 100 g butyl glycol.

Planar PVC substrates and polyester-painted metal panels are spray-coated with the solution, left to flash off for 10 minutes and then dried for an hour at 70° C. in a circulating-air oven.

In both cases, the coatings show good adhesion and resistance to immersion in water (fully satisfactory adhesion test following 24 hours' immersion in demineralized water at RT). In the QUV-A test, neither a yellow colour nor any detachment of the coating can be observed after 500 h. The coating shows good resistance to UV, i.e. to outdoor weathering, and may be used, for example, as a barrier coating system for the application of a photocatalytically active self-cleaning coating layer of titanium oxide. If propyltrimethoxysilane is used instead of N-butylaminopropyltrimethoxysilane in the above-described Example 4, curing temperatures of at least 130° C. are needed in order to obtain similarly good mechanical and chemical resistances on the plastic substrates.

1. Alkali-resistant coating, wherein the coating consists of
a hydrolysable silane of the compounds TEOS, MTEOS or higher-chain alkyl silanes (di- tri- and tetrafunctional silanes), but preferably TEOS, MTEOS or mixtures thereof
and a condensation catalyst based on
a) secondary or tertiary bases (e.g. amino, mercaptosilanes)
and/or
b) Lewis acids as metal alkoxides, such as aluminium alkoxides, zirconium alkoxides and titanium alkoxides
where the ratio (in wt. %) of hydroysable silane to condensation catalyst is between 99:1 and 70:30.

2. Alkali-resistant coating according to claim 1, wherein the coating is diluted with a solvent, especially water, to a solids content of more than 0.05 wt. % and less than 20 wt. %.

3. Alkali-resistant coating according to claim 1, wherein for purposes of surface functionalization, a portion of the alkoxysilanes is fluorinated or contains a hydrophilic side chain, especially polyether.

4. Alkali-resistant coating according to claim 1, wherein the metal alkoxides are preferably aluminium alkoxides and zirconium alkoxides.

5. Alkali-resistant coating according to claim 1, wherein the bases are silanes with a secondary amino group.

6. Alkali-resistant coating according to claim 1, wherein the coating contains nanoparticles, in particular SiO₂ nanoparticles.

7. Process for producing a coating according to claim 1, wherein acid is added to hydrolyse the silane and the catalyst is added immediately after hydrolysis or up to one hour after hydrolysis.

8. Process according to claim 7, wherein the coating is applied by way of roll coating, flooding, spray painting, electrostatic spraying, centrifugal coating, dip coating or wipe coating.

9. Process according to claim 7, wherein curing of the coating is effected at room temperature (RT) up to 1,200° C.

10. Process according to claim 7, wherein the coating is applied as a primer or a thin layer of up to 3 μm coating thickness to the object to be coated.

11. Use of the coating according to claim 1 on metals, especially steel and chromium, metallized plastics, polymers, especially PVC and polyester, glass, ceramics, glass ceramics, natural materials, especially leather, rubber, jute, and cotton, and mineral substrates, especially stone and concrete.

12. Use of the coating according to claim 1 as a primer for hydrophobic coatings or photocatalytically active particles and for non-scaling coating layers on chromium surfaces, stainless steel surfaces, PVC or polyester.

13. Use of the coating according to claim 1 as a base system for anti-fingerprint, photocatalytic and non-scaling coatings, matting agents, paint pigments and flow improvers, for impregnating textiles, leather and paper or as a binder or additive for surface coating systems or polymers.

14. Use of the coating according to claim 1 on household crockery, household appliances, textiles and kitchen and sanitary equipment, in particular on pots, pans, housings of all kinds, fittings, covers, trim, hand-towel holders, paper dispensers, hand dryers, soap dispensers, shower heads, mirror frames, bath-tub and wash-basin closures, shower rails, shower panels, bathroom furniture, lamellae and PVC profiles (window frames, doors, conservatories), facade elements, roller-shutter boxes, sunblinds, textiles, especially industrial fabrics such as awnings, tent roofs and tarpaulins, or (clothing) materials.
